(19) United States
(12) Patent Application Publication
(10) Pub. No.: US 2015/0210128 A1
(43) Pub. Date: Jul. 30, 2015

(54) SNOW CHAIN FOR VEHICLES

(71) Applicant: WOO YOUNG KIM, BUK-GU (KR)

(72) Inventor: WOO YOUNG KIM, BUK-GU (KR)

(21) Appl. No.: 14/587,879

(22) Filed: Dec. 31, 2014

(30) Foreign Application Priority Data
Jan. 29, 2014 (KR) 10-2014-0011255

(51) Int. Cl. B60C 27/20; B60C 27/06

(52) U.S. Cl. CPC B60C 27/20; B60C 27/06

(57) ABSTRACT

A snow chain for vehicles including an antiskid portion having crests and valleys alternately arranged on one surface facing the ground along an edge of each spike member and catch protrusions and a protruding portion formed at the surface of the spike member so as to prevent skid of a vehicle in cooperation with the crests of the antiskid portion, thereby enhancing an antiskid function of the snow chain is provided.

### CROSS-REFERENCE TO RELATED APPLICATIONS

This application claims priority to KR 10-2014-0011255 having a filing date of Jan. 29, 2014, the entire contents of which are hereby incorporated by reference.

### FIELD OF TECHNOLOGY

The following relates to a snow chain for vehicles, and more particularly to a snow chain for vehicles including an antiskid portion having crests and valleys alternately arranged on one surface facing the ground along an edge of each spike member and catch protrusions and a protruding portion formed at the surface of the spike member so as to prevent skid of a vehicle in cooperation with the crests of the antiskid portion, thereby enhancing an antiskid function of the snow chain.

### BACKGROUND

Generally, a snow chain is a device fitted to tires of vehicles to secure safe driving by providing maximum traction when driving on snow or ice. Various types of snow chains are widely used.

Especially, the most commonly used snow chain is configured such that metal rings are connected together in a mesh and mounted on a surface of a vehicle tire. Frictional force of the ring type chain functions to prevent vehicles from skidding on snow or ice.

However, since such a mesh type snow chain should be manufactured to suit a shape of a vehicle tire, manufacturing and assembly processes are complicated and difficult, and manufacturing costs are increased.

In addition, since engagement of the conventional snow chain with the tire is achieved by covering the tire with the snow chain, the snow chain requires a plurality of securing members. Further, since the snow chain should also be secured to the inside of the tire, it is hard to engage and disengage the snow chain, that is, it is quite inconvenient to use the same. Furthermore, the mesh type snow chain in which small metal rings are connected has a problem such that the chain is partially worn or cut by friction with the ground during traveling of the vehicle. In such a case, a broken portion of the chain may be drawn into the tire, which may cause a problem in that the tire should be separated from the vehicle body to withdraw the chain.

A conventional antiskid device for vehicles is disclosed in Korean Patent No. 10-1033019 (issued on May 9, 2011). The conventional antiskid device for vehicles includes a plurality of spikes each composed of an insertion member, an intermediate portion of which has a V shape for insertion into a space formed between double wheels, and a close contact member which is integrally formed in a flat shape with both sides of the insertion member so as be brought into close contact with the surface of each tire of the double wheels, a connection member which connects the spikes such that the spikes are arranged at regular intervals, and a fastening device which fastens one end of the connection member to the other end of the connection member. The fastening device includes: a coupling body including a body section open at both ends thereof, a holding section secured to a lower portion of the body section and having a holding hole for connection with the connection member, and a reverse movement prevention member secured to the lower portion of the body; and a fastening body including a head portion formed at one end thereof, a hook portion formed at the other end thereof, and a saw-toothed portion formed between the head portion and the hook portion. When the fastening body is inserted into the coupling body, the saw-toothed portion is caught by the reverse movement prevention member.

However, such a conventional snow chain including the antiskid device configured as described above has a problem in that secure contact with the whole area of the snowy road on which tires roll is not achieved, durability is relatively low, and friction is relatively low due to a rounded surface.

### SUMMARY

An aspect relates to a snow chain for vehicles including an antiskid portion having crests and valleys alternately arranged on one surface facing the ground along an edge of each spike member and catch protrusions and a protruding portion formed at the surface of the spike member so as to prevent skid of a vehicle in cooperation with the crests of the antiskid portion, and configured such that snow adhered to a concave surface of the spike member facing the ground can be easily discharged outside through first and second passage recesses and the valleys of the antiskid portion during traveling of the vehicle, thereby enhancing an antiskid function of the snow chain.

Another aspect of embodiments of the present invention is to provide a snow chain for vehicles capable of preventing separation of the snow chain by a resilient support member mounted on the spike member so as to firmly secure a connection member connecting the spike members to each other.

A further aspect of embodiments of the present invention is to provide a snow chain for vehicles enabling a user to successively assemble a plurality of spike members having the same structure corresponding to an outer diameter of a tire using connection members, thereby facilitating manufacture and assembly processes, considerably reducing manufacturing costs, and enabling easy repair or replacement of a worn or broken component.

In accordance with one aspect of embodiments of the present invention, a snow chain for vehicles includes: a plurality of plate-shaped spike members connected to each other by connection members to be mounted on an outer surface of a tire, wherein each of the spike members includes: an antiskid portion including crests and valleys alternately arranged on one surface facing the ground along an edge of the spike member, the crests of the antiskid portion having a sharp pointed tip; a protruding portion convexly formed in a longitudinal direction on a middle portion of the surface of the spike member on which the antiskid portion is formed; first passage recesses formed between upper and lower ends of the spike member and both ends of the protruding portion in the longitudinal direction thereof spaced apart from the upper and lower ends of the spike member; a pair of hook engagement slots formed in the longitudinal direction of the protruding portion and spaced apart from each other; hollow catch protrusions separated from both sides of the protruding portion and each having a protruding periphery; second passage recesses formed between the antiskid portion and the catch protrusions and between the protruding portion and the catch protrusions so as to be connected to the valleys of the antiskid portion and the first passage recesses; and a resilient support member made of a resilient material and mounted on the other surface of the spike member so as to block part of the hook engagement slots formed at the protruding portion, and wherein each of the connection members has a bottom surface having a curvature corresponding to an arc of the tire and includes: hooks formed at both ends in a longitudinal direction thereof so as to be engaged with the hook engagement slots of the adjacent spike members; and catch recesses formed on an outer surface of the hooks, by which both ends of the resilient support member are bent and caught when the hooks are engaged with the hook engagement slots.

### BRIEF DESCRIPTION

The above and other aspects, features and advantages of the invention will become apparent from the following description of the following embodiments given in conjunction with the accompanying drawings, in which

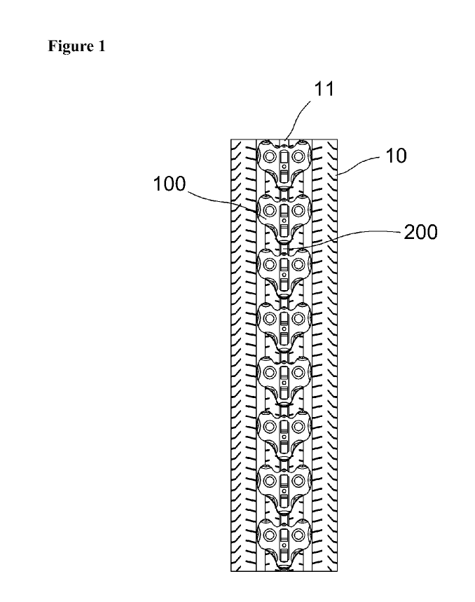

FIG. 1 is a plan view of a snow chain for vehicles according to an exemplary embodiment of the present invention, which is mounted on a tire;

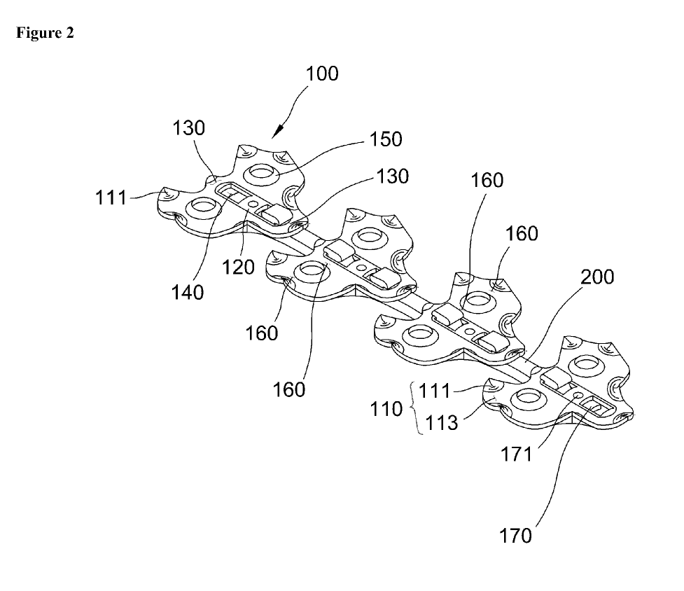

FIG. 2 is a perspective view of spike members connected to each other by connection members according to the exemplary embodiment of the present invention;

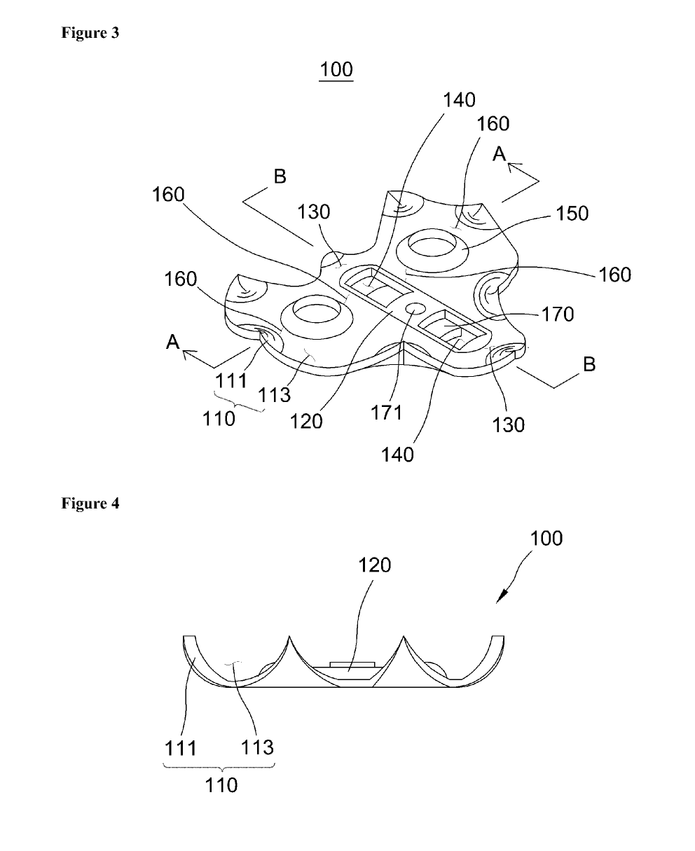

FIG. 3 is an enlarged perspective view of the spike member according to the exemplary embodiment of the present invention;

FIG. 4 is a side view of the spike member according to the exemplary embodiment of the present invention;

FIG. 5 is a cross-sectional view taken along line A-A in FIG. 3;

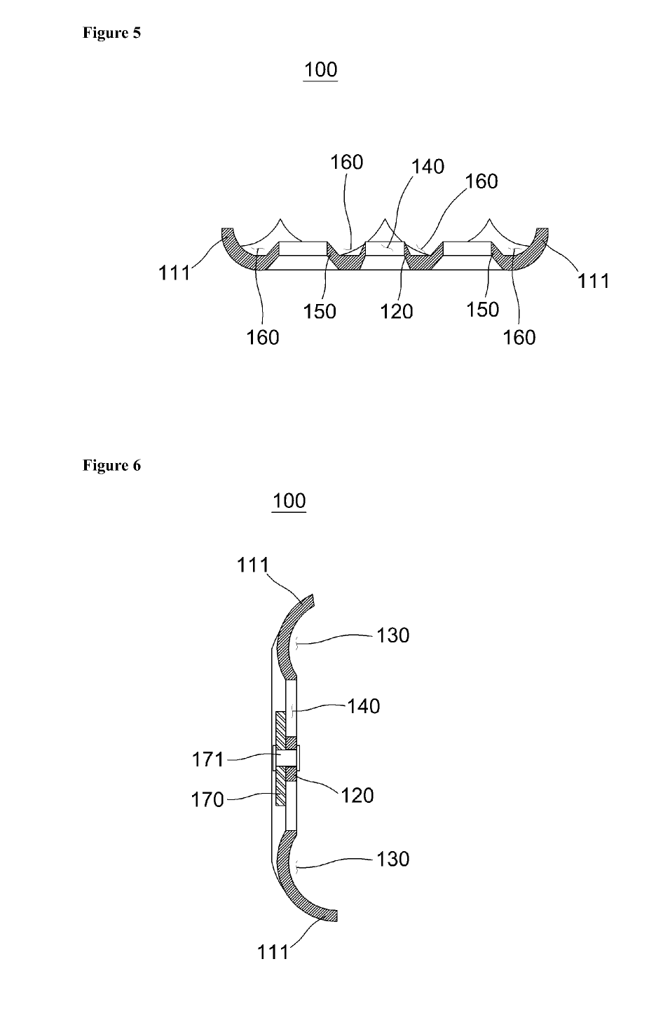

FIG. 6 is a cross-sectional view taken along line B-B in FIG. 3;

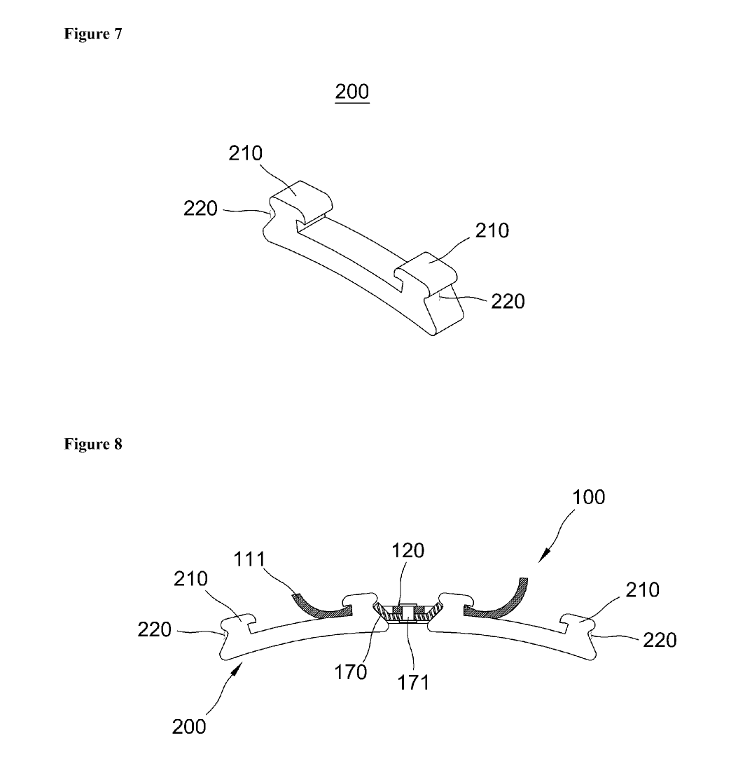

FIG. 7 is a perspective view of the connection member according to the exemplary embodiment of the present invention;

FIG. 8 is a cross-sectional view of the spike member and the connection members according to the present invention, which are connected to each other;

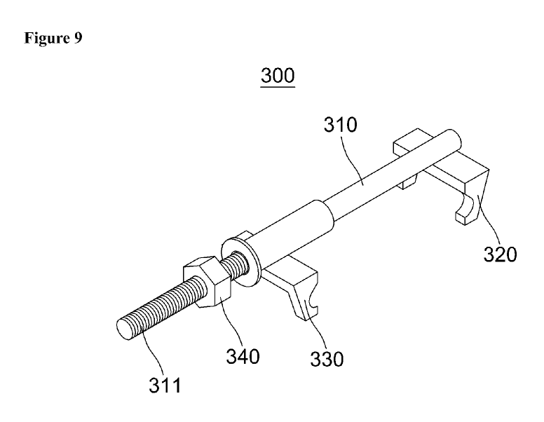

FIG. 9 is a perspective view of a connection device according to the exemplary embodiment of the present invention; and

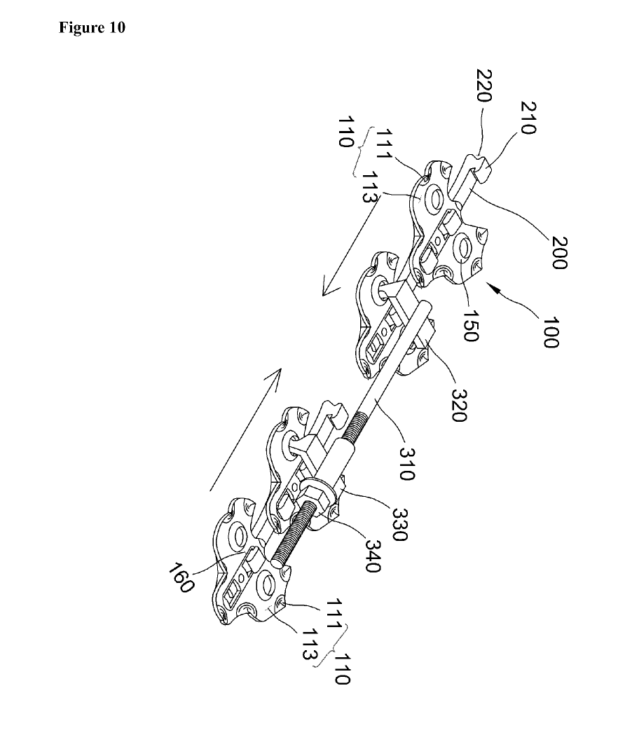

FIG. 10 is a perspective view of the first spike member and the last spike member connected to each other by the connection device according to the exemplary embodiment of the present invention.

### DETAILED DESCRIPTION

Hereinafter, exemplary embodiments of the present invention will be described in detail with reference to the accompanying drawings. Detailed descriptions of publicly known functions, configuration and other matters apparent to those skilled in the art will be omitted for clarity in description of embodiments of the present invention.

In addition, the terms used herein are defined by taking functions of embodiments of the present invention into account and can be changed according to user or operator custom or intention. Further, it should be noted that the drawings are not to precise scale and may be exaggerated in thickness of lines or size of components for descriptive convenience and clarity. It should be understood that the following embodiments are given by way of illustration only and do not limit the scope of embodiments of the present invention, and that various modifications, alterations, and equivalent embodiments can be made by those skilled in the art without departing from the spirit and scope of embodiments of the present invention.

FIG. 1 is a plan view of a snow chain for vehicles according to an exemplary embodiment of the present invention, which is mounted on a tire; FIG. 2 is a perspective view of spike members connected to each other by connection members according to the exemplary embodiment of the present invention; FIG. 3 is an enlarged perspective view of the spike member according to the exemplary embodiment of the present invention; FIG. 4 is a side view of the spike member according to the exemplary embodiment of the present invention; FIG. 5 is a cross-sectional view taken along line A-A in FIG. 3; FIG. 6 is a cross-sectional view taken along line B-B in FIG. 3; FIG. 7 is a perspective view of the connection member according to the exemplary embodiment of the present invention; FIG. 8 is a cross-sectional view of the spike member and the connection members according to embodiments of the present invention, which are connected to each other; FIG. 9 is a perspective view of a connection device according to the exemplary embodiment of the present invention; and FIG. 10 is a perspective view of the first spike member and the last spike member connected to each other by the connection device according to the exemplary embodiment of the present invention.

Referring to FIGS. 1 to 10, a snow chain for vehicles according to one exemplary embodiment of the present invention comprises a plurality of plate-shaped spike members configured to be connected to each other by connection members and mounted on an outer surface of a tire. Each spike member 100 includes an antiskid portion 110, a protruding portion 120, catch protrusions 150, and a resilient support member 170.

The antiskid portion 110 includes crests 111 and valleys 113 alternately arranged on one surface facing the ground along an edge of the spike member 100. The crests 111 and the valleys 113 of the antiskid portion 110 may have a smooth curved shape.

When such a snow chain is mounted on a tire 10 and a vehicle runs on the snowy road, the antiskid portion 110 directed toward the ground functions to dig into ice or snow, thereby preventing slipping of the tire 10.

To this end, the crests of the antiskid portion 110 may have a sharp pointed tip.

The protruding portion 120 is convexly formed in a longitudinal direction on a middle portion of the surface of the spike member 100 on which the antiskid portion 110 is formed. Both ends of the protruding portion 120 in the longitudinal direction thereof are spaced a predetermined distance from upper and lower ends of the spike member 100 such that first passage recesses 130 are formed between both ends of the protruding portion 120 in the longitudinal direction thereof and the upper and lower ends of the spike member 100.

In other words, when the crests 111 of the antiskid portion 110 are formed at the upper and lower ends of the spike member 100, the first passage recesses 130 are formed between both ends of the protruding portion 120 in the longitudinal direction thereof and the crests 111 of the antiskid portion 110.

The protruding portion 120 has a pair of hook engagement slots 140 which are spaced a predetermined distance from each other and formed in the longitudinal direction of the protruding portion 120. Connection members 200 are engaged with the hook engagement slots 140 to connect the spike members 100.

The spike member 100 further includes hollow catch protrusions 150 which are separated from both sides of the protruding portion 120 and each of which has a protruding periphery. Second passage recesses 160 connected to the valleys of the antiskid portion 110 and the first passage recesses 130 are formed between the antiskid portion 110 and the catch protrusions 150 and between the protruding portion 120 and the catch protrusions 150.

Herein, when a vehicle runs with the spike members 100 connected to each other by the connection members 200 and mounted on the tire, snow on the road is adhered to the surface of the spike member 100.

That is, when the spike member 100 is initially brought into contact with the road, snow on the road is adhered to the valleys of the antiskid portion 110 and the first and second passage recesses 130, 160, which are defined by the crests 111 of the antiskid portion 110, the catch protrusions 150 and the protruding portion 120.

In this state, if the tire 10 makes one rotation and thus the spike member 100 comes into contact with the road again, snow is newly added to the snow adhered to the first and second passage recesses 130, 160 and the valleys of the antiskid portion 110. At this time, the snow is discharged outside through the first and second passage recesses 130, 160 and the valleys of the antiskid portion 110 by the weight of the vehicle. Accordingly, the antiskid function by the crests of the antiskid portion 110, the catch protrusions 150 and the protruding portion 120 can be consistently maintained.

Here, it should be noted that the first and second passage recesses 130, 160 and the valleys 113 of the antiskid portion 110 are formed to be naturally connected to each other.

The resilient support member 170 made of a resilient material is mounted on the other surface of the spike member 100 so as to block part of the hook engagement slots 140 formed at the protruding portion 120.

The resilient support member 170 is coupled to the spike member 100 by a securing rivet 171 fitted into a coupling hole (not shown) formed between the pair of hook engagement slots. Both ends of the resilient support member 170 coupled to the other surface of the spike member 100 by the securing rivet 171 block part of the hook engagement slots 140, respectively.

Each connection member 200 includes hooks 210 which are integrally formed at both ends in a longitudinal direction thereof so as to be engaged with the hook engagement slots 140 of the adjacent spike members 100.

In other words, the spike members 100 are connected to each other by engaging the hooks 210 of the connection members 200 with the hook engagement slots 140.

The connection member 200 further includes catch recesses 220 formed on an outer surface of the hooks 210. When the hooks 210 are engaged with the hook engagement slots 140, the resilient support member 170 is bent such that both ends thereof are caught by the catch recesses 220.

In other words, when the hooks 210 of the connection members 200 are engaged with the hook engagement slots 140 and thus both ends of the resilient support member 170 are bent and caught by the catch recesses 220, the resilient support member 170 resiliently pushes the connection members 200 in an engagement direction. Accordingly, engagement of the connection members 200 can be more securely achieved, and separation of the connection members 200 can be prevented since the resilient support member 170 is caught by the catch recesses 220.

The connection members 200 may have a bottom surface having a curvature corresponding to an arc of the tire. Since the connection members 200 are fitted into a drain groove of the tire, that is, since the bottom surface of the connection members 200 has a curvature corresponding to an arc shape of the tire, the spike members 100 may be disposed to form smooth surface-contact with the outer surface of the tire.

In a mounting state of the above-structured snow chain according to embodiments of the present invention, a plurality of spike members 100 are connected to each other through the connection members 200 and mounted on the outer surface of the tire such that the connection members 200 can be fitted into the drain groove of the tire.

In order to connect the first spike member 100 to the last spike member 100 using the connection member, a connection device 300 may be used to pull the last spike member 100 toward the first spike member 100. The connection device 300 includes a rod 310 having a predetermined length and threads 311 formed at one end thereof, a first insertion member 320 integrally formed at the other end of the rod 310 and having both ends inserted into and caught by the hollow catch protrusions 150 formed at the spike member 100, a second insertion member 330 movably coupled to the rod 310 and having both ends inserted into and caught by the hollow catch protrusions 150 formed at the spike member 100, and a fastening nut 340 meshed with the threads 311 of the rod 310 to fasten the second insertion member 330.

Specifically, after the first insertion member 320 is inserted into and caught by the hollow catch protrusions 150 of the first spike member 100 and the second insertion member 330 is inserted into and caught by the hollow catch protrusions 150 of the last spike member 100, the fastening nut 340 is rotated to move the second insertion member 330 toward the first insertion member 320, thereby moving the last spike member 100 toward the first spike member 100.

Then, the hooks 210 formed at both ends of the connection member 200 are inserted into and caught by the hook engagement slot 140 of the first spike member 100 and the hook engagement slot 140 of the last spike member 100, which completes the process of mounting the snow chain of embodiments of the present invention on the tire.

As such, according to embodiments of the present invention, by virtue of the antiskid portion formed on one surface facing the ground along an edge of each spike member and the catch protrusions and the protruding portion formed at the surface of the spike member, the snow chain has an enhanced antiskid function. In addition, since snow adhered to the concave surface of the spike member facing the ground can be easily discharged outside through the first and second passage recesses and the valleys of the antiskid portion during traveling of the vehicle, the antiskid function of the snow chain can be further enhanced.

Further, since the connection member connecting the spike members to each other is firmly secured by the resilient support member, separation of the snow chain can be prevented. Furthermore, since a plurality of spike members having the same structure are successively assembled corresponding to an outer diameter of a tire by the connection members, manufacturing and assembly processes are facilitated, thereby considerably reducing manufacturing costs. When the snow chain is partially worn or breaks down, only a damaged component can be repaired or replaced. Accordingly, the snow chain has improved lifespan through reuse of the snow chain

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

What is claimed is:

1. A snow chain for vehicles including a plurality of plate-shaped spike members connected to each other by connection members to be mounted on an outer surface of a tire, wherein each of the spike members comprises:
an antiskid portion including crests and valleys alternately arranged on one surface facing the ground along an edge of the spike member, the crests of the antiskid portion having a sharp pointed tip;
a protruding portion convexly formed in a longitudinal direction on a middle portion of the surface of the spike member on which the antiskid portion is formed;
first passage recesses formed between upper and lower ends of the spike member and both ends of the protruding portion in the longitudinal direction thereof spaced apart from the upper and lower ends of the spike member;
a pair of hook engagement slots formed in the longitudinal direction of the protruding portion and spaced apart from each other;
hollow catch protrusions separated from both sides of the protruding portion and each having a protruding periphery;
second passage recesses formed between the antiskid portion and the catch protrusions and between the protruding portion and the catch protrusions so as to be connected to the valleys of the antiskid portion and the first passage recesses; and
a resilient support member made of a resilient material and mounted on the other surface of the spike member so as to block part of the hook engagement slots formed at the protruding portion, and
wherein each of the connection members has a bottom surface having a curvature corresponding to an arc of the tire and comprises:
hooks formed at both ends in a longitudinal direction thereof so as to be engaged with the hook engagement slots of the adjacent spike members; and
catch recesses formed on an outer surface of the hooks, by which both ends of the resilient support member are bent and caught when the hooks are engaged with the hook engagement slots.
